(19) United States
(12) Patent Application Publication
(10) Pub. No.: US 2019/0315591 A1
(43) Pub. Date: Oct. 17, 2019

(54) ELEVATOR CONTROL BUTTON ASSEMBLY

(71) Applicant: Otis Elevator Company, Farmington, CT (US)

(72) Inventor: Victor Peigne, Gien (FR)

(21) Appl. No.: 16/383,931

(22) Filed: Apr. 15, 2019

(30) Foreign Application Priority Data
Apr. 16, 2018 (EP) 18305468.3

(51) Int. Cl. B66B 1/16; B66B 1/52; B66B 9/00

(52) U.S. Cl. CPC B66B 1/16; B66B 2201/463; B66B 9/00; B66B 1/52

(57) ABSTRACT

An elevator control button assembly (7), in particular an elevator hall call button (7a), to be employed in an elevator system (2) comprises a stationary reference element (22); an activation element (26), which is movable with respect to the reference element (22); and at least two rods (24a-24d). The at least two rods (24a-24d) are arranged non-parallel to each other between the reference element (22) and the activation element (26). Each of the rods (24a-24d) contacts the reference element (22) and the activation element (26), respectively. The at least two rods (24a-24d) are configured for moving when the activation element (26) is moved with respect to the reference element (22).

The invention relates to an elevator control button assembly and to an elevator system comprising such an elevator control button assembly.

An elevator system comprises at least one elevator car traveling along a hoistway between a plurality of landings. For controlling the movement of the elevator car, elevator control buttons are provided at the landings (elevator hall call buttons) and within the elevator car (elevator car control buttons). Conventional elevator control buttons may be difficult to identify and to operate for a passenger and/or mechanic

It therefore is desirable to provide improved elevator control buttons, in particular elevator control buttons which are easier to identify and to operate.

According to an exemplary embodiment of the invention, an elevator control button assembly, which is configured to be employed in an elevator system, comprises a stationary reference element, a movable activation element, and at least two rods. The activation element is movable with respect to the reference element. The at least two rods are arranged between the reference element and the activation element extending non-parallel to each other. Each of the rods contacts the reference element and the activation element. The rods are configured to move, in particular pivot, when the activation element is moved with respect to the reference element.

The rods arranged between the reference element and the activation element prevent an undesirable tilting and/or jamming of the activation element even in case the activation element covers a large surface area, in particular a surface area which is considerably larger than the activation surfaces of conventional elevator control buttons. The at least two rods further ensure that the activation element reliably returns to its released (non-activated) position when no external force is applied. Thus, an elevator control button assembly according to an exemplary embodiment of the invention may have a larger activation surface area than conventional elevator control buttons.

As a result, a reliable elevator control button assembly with an increased activation surface area may be provided. An elevator control button assembly with such increased activation surface area is easier to identify and to activate than conventional elevator control buttons. The invention provides an elevator control button which can be activated by pushing anywhere on its increased activation surface.

Exemplary embodiments of the invention also include an elevator system comprising an elevator car traveling along a hoistway and at least one elevator control button assembly according to an exemplary embodiment of the invention. The at least one elevator control button assembly may be employed as an elevator hall call button or as an elevator car control button. An elevator system employing such an elevator control button assembly is easier to operate than an elevator system comprising conventional elevator control buttons.

A number of optional features are set out in the following. These features may be realized in particular embodiments, alone or in combination with any of the other features.

The reference element and the activation element may be planar elements extending parallel to each other. The reference element and the activation element in particular may be rectangular plates, for example quadratic plates, or round plates, for example elliptical or circular plates, extending parallel to each other.

It is, however, not mandatory that the reference element and the activation element extend parallel to each other, as long as the activation element may be moved properly with respect to the reference element.

For allowing easy identification and activation of the activation element, the activation element may have an extension of at least 5 cm×5 cm in two orthogonal dimensions (width and length), in particular an extension of at least 8 cm×8 cm, more particularly an extension of at least 10 cm×10 cm.

The dimensions of the reference element may basically correspond with the dimensions of the activation element.

In order to provide an electric switching functionality, the elevator control button assembly may comprise at least one electrical switch configured to be activated by the movement of the activation element with respect to the reference element.

The rods may be configured for pushing the activation element into a released (non-activated) position when no external force is applied to the activation element in order to ensure that the activation element is arranged in the released position when no external force is applied.

At least one of the rods may comprise a main portion and at least one end portion. The at least one end portion may be bent or cranked with respect to the main portion in order to allow elastically fixing the at least one rod to at least one of the reference element and the activation element. The at least one rod in particular may comprise two bent or cranked end portions allowing both ends of the at least one rod to be elastically fixed to at least one of the reference element or the activation element, respectively.

Elastically fixing the at least one rod to the reference element or to the activation element causes the at least one rod to push the activation element into its released (non-activated) position when no external force is applied to the activation element.

For providing an efficient elastic fixation of the at least one rod, the at least one end portion may be bent or cranked with respect to the main portion at an angle between 85° and 95°, in particular at an angle of 88° to 92°, more particularly at an angle of 90°.

At least one of the reference element and the activation element may comprise at least one fixing portion which is configured for elastically fixing one of the rods, in particular an end portion of one of the rods, to the respective element.

Each of the fixing portions may comprise two legs extending parallel to each other from the reference element or from the activation element, respectively. The legs in particular may extend orthogonally from the respective element.

An end portion of one of the rods may be clamped between the two legs for elastically fixing the rod to the respective element.

At least one of the reference element and the activation element may comprise at least one guiding portion which is configured for guiding one of the rods, in particular an end portion of one of the rods, when the rods are moved with respect to the elements in order to ensure a well-defined movement of the rod with respect to the respective element.

The at least one fixing portion and/or the at least one guiding portion may be formed integrally with the reference element or with the activation element, respectively.

Alternatively, the at least one fixing portion and/or the at least one guiding portion may be attached or mounted to the reference element or to the activation element, respectively.

At least one of the reference element and the activation element may be made of a plastic material having a low weight and allowing producing the elements at low costs. Alternatively, at least one of the reference element and the activation element may be made of a metallic material, e.g. aluminum or stainless steel. The activation element may be made at least partially from transparent material.

The elevator control button assembly may further comprise at least one light source configured for illuminating the activation element for constituting a background illumination of the elevator control button assembly.

The rods may be made of a metallic material, such as steel, providing the desired strength and flexibility.

Two of the at least two rods may be arranged in an L-shaped configuration. In particular the two rods may extend along a periphery of the reference element and the activation element. Alternatively, the two rods may be arranged in an X-shaped configuration thereby crossing a center region of the reference element and the activation element, respectively.

The elevator control button assembly may comprise more than two rods, in particular three or four rods. Three rods may be arranged in a triangular configuration. Four rods may be arranged in a rectangular configuration, in particular in a quadratic configuration.

When projected onto the reference element, the projections of at least two rods may intersect each other. This configuration provides a particularly strong configuration of the rods.

Alternatively, the projections of the rods onto the reference element may be arranged in a configuration in which they do not intersect with each other in order to reliably avoid any interference between the rods.

In the following an exemplary embodiment of the invention is described with reference to the enclosed figures.

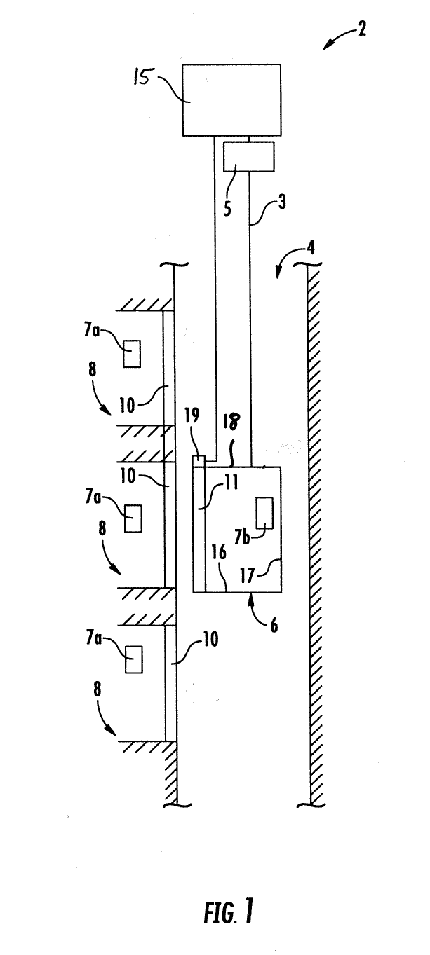

FIG. 1 schematically depicts an elevator system comprising an elevator car according to an exemplary embodiment of the invention.

FIG. 2 schematically depicts a front view of a landing door (elevator hoistway door) of an elevator system including an elevator control button assembly according to an exemplary embodiment of the invention.

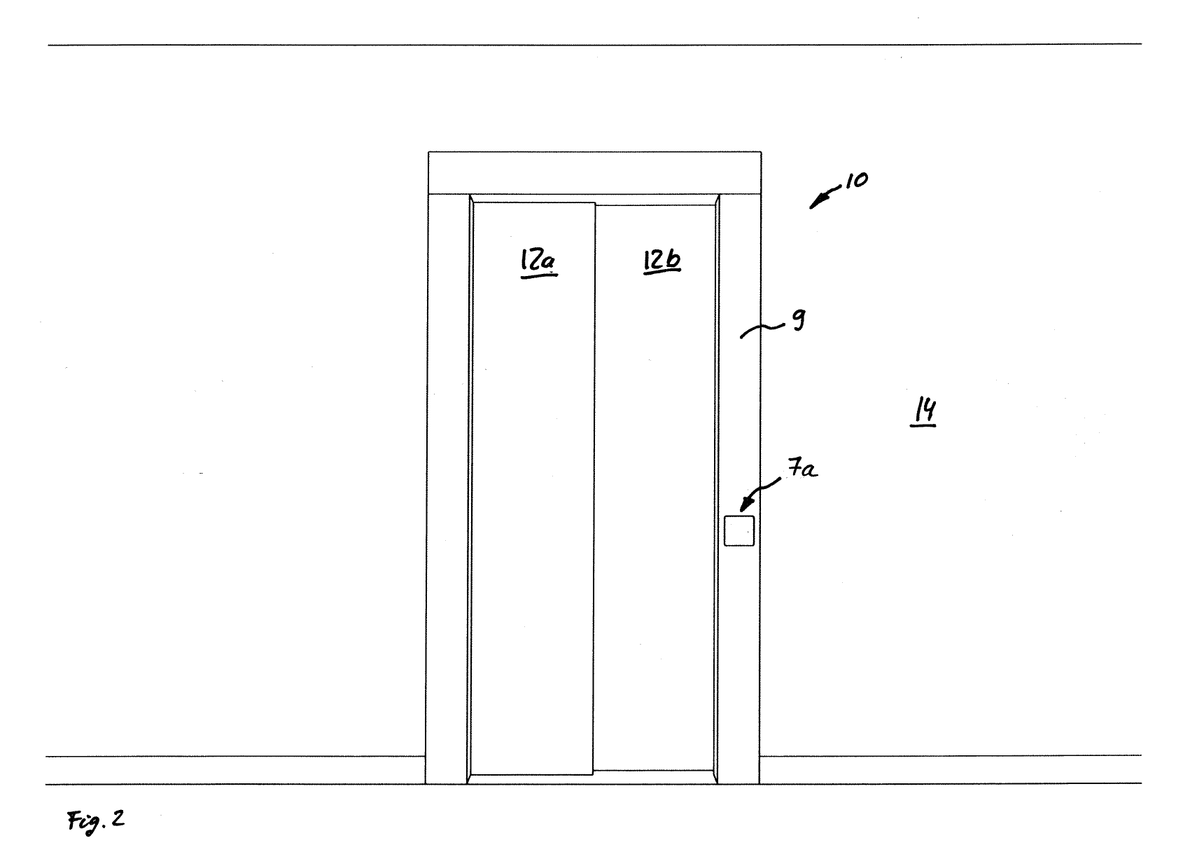

FIG. 3 depicts a perspective explosive view of an elevator control button assembly according to an exemplary embodiment of the invention.

FIG. 4 depicts a plane view onto the elevator control button assembly shown in FIG. 3.

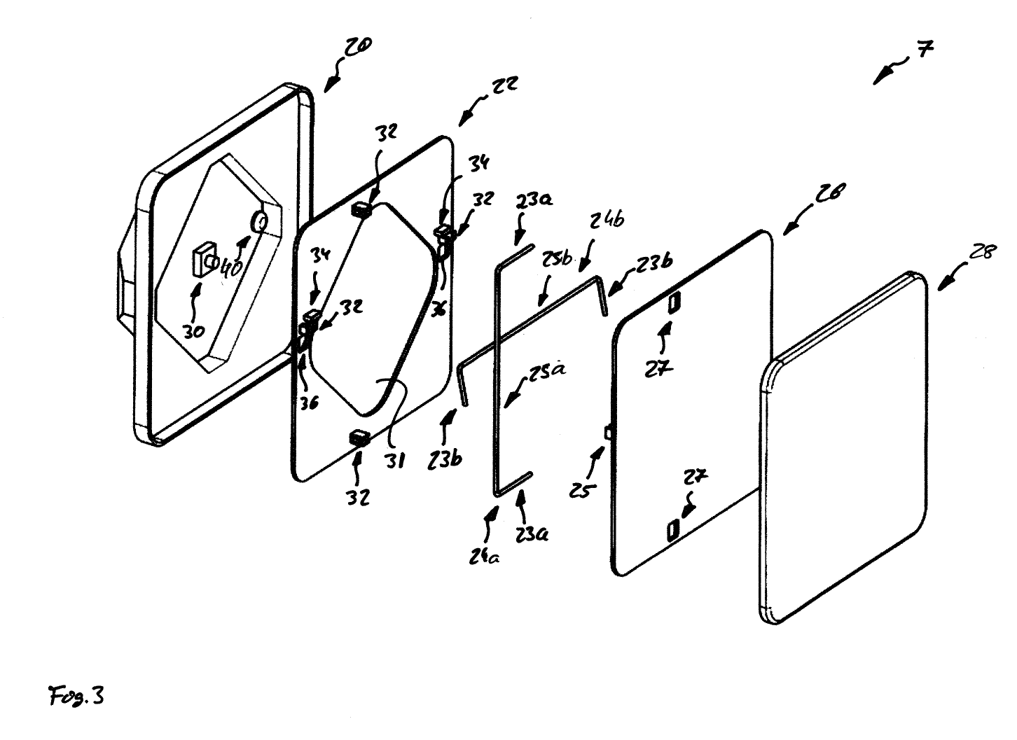

FIG. 5a depicts a perspective view of the elevator control button assembly in a released state.

FIG. 5b depicts a side view of the elevator control button assembly in the released state.

FIG. 6a depicts a perspective view of the elevator control button assembly in an activated state.

FIG. 6b depicts a side view of the elevator control button assembly in the activated state.

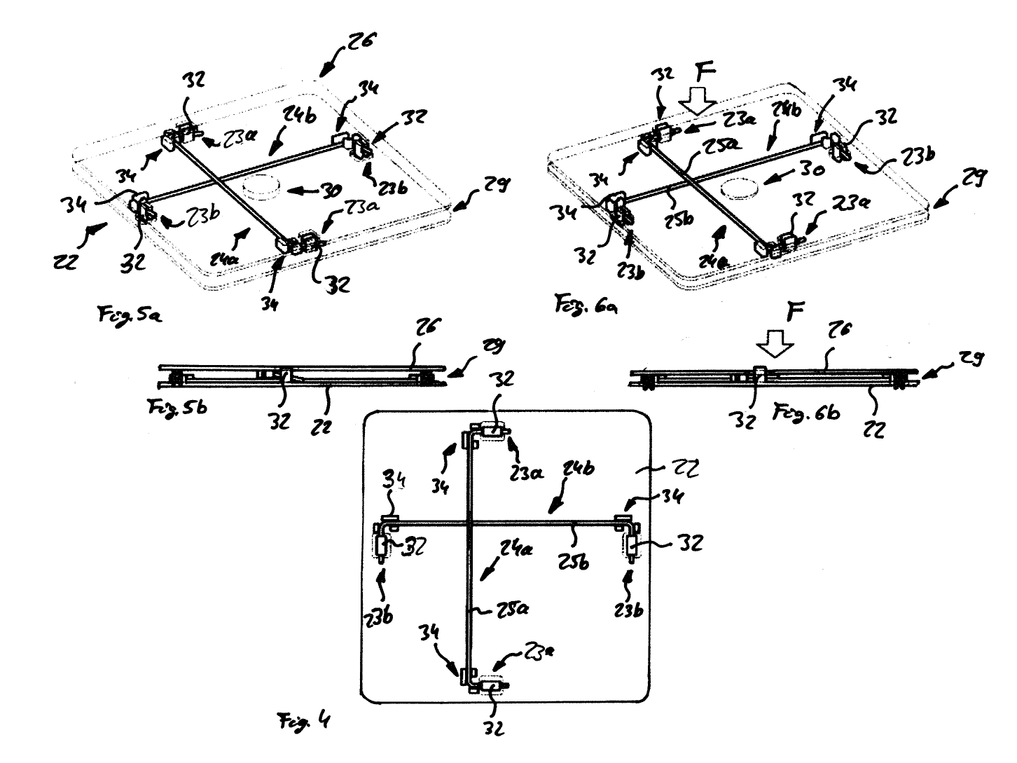

FIGS. 7 to 11 depict plane views onto elevator control button assemblies according to alternative embodiments of the invention.

FIG. 1 schematically depicts an elevator system 2 comprising an elevator car 6 according to an exemplary embodiment of the invention.

The elevator system 2 comprises a hoistway 4 extending in a longitudinal direction between a plurality of landings 8 located on different floors.

The elevator car 6 comprises a floor 16, a ceiling 18 and sidewalls 17 extending between the floor 16 and the ceiling 18 defining an interior space of the elevator car 6. Only one sidewall 17 is depicted in the schematic illustration of FIG. 1.

The elevator car 6 is movably suspended within the hoistway 4 by means of a tension member 3. The tension member 3, for example a rope or belt, is connected to a drive 5, which is configured for driving the tension member 3 in order to move the elevator car 6 along the longitudinal direction/height of the hoistway 4 between the plurality of landings 8.

Each landing 8 is provided with a landing door (elevator hoistway door) 10, and the elevator car 6 is provided with a corresponding elevator car door 11 allowing passengers to transfer between a landing 8 and the interior space of the elevator car 6 when the elevator car 6 is positioned at the respective landing 8.

The exemplary embodiment of the elevator system 2 shown in FIG. 1 employs a 1:1 roping for suspending the elevator car 6. The skilled person, however, easily understands that the type of the roping is not essential for the invention and that different kinds of roping, e.g. a 2:1 roping, may be used as well. The elevator system 2 may further include a counterweight (not shown) moving concurrently and in opposite direction with respect to the elevator car 6. Alternatively, the elevator system 2 may be an elevator system 2 without a counterweight, as it is shown in FIG. 1. The drive 5 may be any form of drive used in the art, e.g. a traction drive, a hydraulic drive or a linear drive. The elevator system 2 may have a machine room or may be a machine room-less elevator system. The elevator system 2 may use a tension member 3, as it is shown in FIG. 1, or it may be an elevator system without a tension member 3, comprising e.g. a hydraulic drive or a linear drive (not shown).

The drive 5 is controlled by an elevator control 15 for moving the elevator car 6 along the hoistway 4 between the different landings 8.

Input to the elevator control 15 may be provided via elevator hall call buttons 7a, which are provided on each landing 8 close to the elevator landing doors 10, and/or via elevator car control buttons 7b provided inside the elevator car 6.

The elevator hall call buttons 7a and the elevator car control buttons 7b may be connected to the elevator control 15 by means of electrical lines, which are not shown in FIG. 1, in particular by an electric bus, e.g. a field bus such as a CAN bus, or by means of wireless data connections.

In order to determine the current position of the elevator car 6, the elevator car 6 is provided with a position sensor 19. The position sensor 19 may be arranged at the top of the elevator car 6 as shown in FIG. 1. Alternatively, the position sensor 19 may be provided at a side of the elevator car 6 or at the bottom, e.g. below a floor 16, of the elevator car 6.

FIG. 2 schematically depicts a front view of one of the landing doors 10 of the elevator system 2. The landing door 10 comprises a landing door frame 9 and two movable landing door panels 12a, 12b.

An elevator hall call button 7a according to an exemplary embodiment of the invention is provided at the landing door frame 9.

The skilled person will understand that more than one elevator hall call button 7a may be provided at each landing 8. In particular, a first elevator hall call button 7a for traveling upwards and a similar second elevator hall call button (not shown in FIG. 2) for traveling downwards may be provided. The skilled person further understands that, alternatively to mounting the elevator hall call button(s) 7a to the door frame 9, the elevator hall call button(s) 7a may be mounted to a wall 14 next to the landing door 10 or to a separate elevator control unit (not shown) arranged in the vicinity of the landing door 10.

FIG. 3 depicts a perspective explosive view of an elevator control button assembly 7 according to an exemplary embodiment of the invention. The elevator control button assembly 7 may be used as an elevator hall call button 7a or as an elevator car control button 7b, respectively. FIG. 4 depicts a sectional view through the elevator control button assembly 7 shown in FIG. 3.

The elevator control button assembly 7 comprises a base (housing) 20, which may be mounted to the frame 9 of a landing door 10, to a wall 14 next to a landing door 10, to a separate elevator control unit, or to a sidewall 17 of an elevator car 6 (cf. FIG. 1).

At least one electrical switch 30 is provided at the base 20.

A stationary reference element 22, in particular a planar (plate-shaped) reference element 22, is non-movably arranged within the base 20. An opening 31 is formed in a central portion of the stationary reference element 22 opposite to the at least one electrical switch 30.

The reference element 22 is equipped with a plurality of fixing portions 32 and guiding portions 34, respectively protruding from the side of the reference element 22 facing away from the base 20. The fixing portions 32 and the guiding portions 34 may be formed integrally with the reference element 22. Alternatively, the fixing portions 32 and the guiding portions 34 may be attached or mounted to the reference element 22.

The fixing portions 32 and the guiding portions 34 are configured for fixing and guiding two rods 24a, 24b provided on the side of the reference element 22 facing away from the base 20.

Each of the rods 24a, 24b comprises a straight central main portion 25a, 25b, and two end portions 23a, 23b, which are bent/cranked with respect to the main portions 25a, 25b. The end portions 23a, 23b in particular are bent/cranked at an angle of 85° to 95° with respect to the main portions 25a, 25b, in particular at an angle of 88° to 92°, more particularly at an angle of 90°.

The two rods 24a, 24b are attached to the reference element 22 via the fixing portions 32. Each fixing portion 32 comprises two legs extending parallel to each other orthogonally from the surface of the reference element 22. An end portion 23a, 23b of one of the rods 24a, 24b is clamped between each pair of legs, respectively. Next to at least some of the fixing portions 32, apertures 36 are formed within the reference element 22.

The two rods 24a, 24b extend non-parallel to each other parallel to the reference element 22. In the configuration illustrated in FIGS. 3 and 4, the two rods 24a, 24b in particular extend orthogonally to each other. When projected onto the reference element 22, the projections of the rods 24a, 24b intersect each other (cf. FIG. 4).

A movable activation element 26, in particular a planar (plate-shaped) activation element 26 extending parallel to the reference element 22, is provided next to the rods 24a, 24b opposite to the reference element 22.

The reference element 22 and the activation element 26 are arranged so that the rods 24a, 24b are arranged in a gap 29 (cf. FIGS. 5a, 5b, 6a, 6b) between the reference element 22 and the activation element 26 and contact both elements 22, 26. In particular, the bent/cranked end portions 23a, 23b of the rods 24a, 24b contact (are fixed to) the fixing portions 32 of the reference element 22, and the outer periphery of the straight main portions 25a, 25b of the rods 24a, 24b abut laterally against the activation element 26.

The activation element 26 comprises protrusions 25 protruding towards the reference element 22. The protrusions 25 are formed at positions corresponding to the apertures 36 formed within the reference element 22 allowing the protrusions 25 to extend through the apertures 36 formed within the reference element 22. The activation element 26 further comprises openings 27 formed at positions corresponding to the positions of at least some of the fixing elements 32 allowing said fixing elements 32 to pass through the openings 27 when the activation element 26 is moved towards the reference element 22.

A cover plate 28 is provided on the side of the activation element 26 facing away from the rods 24a, 24b. In an assembled state, the outer periphery of the cover plate 28 is fixed to the periphery of the base 20. The cover plate 28 delimits the movement of the activation element 26. The cover plate 28 is at least partially flexible in order to allow moving the activation element 26 towards the reference element 22 by pressing onto the cover plate 28 deforming the cover plate 28 towards the reference element 22.

The base 20, the reference element 22, the activation element 26 and the cover plate 28 may be made of a plastic material or a metallic material. The rods 24a, 24b may be made of a metal such as (stainless) steel.

The activation element 26 and the cover plate 28 may be at least partially transparent allowing light emitted by at least one light source 40 provided at the base 20 to pass through for establishing a background illumination of the cover plate 28.

In an alternative configuration, which is not shown in the figures, at least some of the fixing elements 32 and/or of the guiding elements 34 may be provided at the activation element 26 instead of the reference element 22 for allowing at least one of the rods 24a, 24b to be attached to the activation element 26.

Operation of the exemplary elevator control button assembly 7 depicted in FIGS. 3 and 4 is described in the following with reference to FIGS. 5a, 5b, 6a and 6b.

FIG. 5a depicts a perspective view of the elevator control button assembly 7 in a released, i.e. not activated, state, and FIG. 5b depicts a side view of the elevator control button assembly 7 in the released state.

FIG. 6a depicts a perspective view of the elevator control button assembly 7 in an activated state, and FIG. 6b depicts a side view of the elevator control button assembly 7 in the activated state.

For clarity of illustration, only the reference element 22, the activation element 26, the electrical switch 30 and the two rods 24a, 24b are depicted in FIGS. 5a, 5b, 6a and 6b.

The bent/cranked ends 23a, 23b of the rods 24a, 24b are attached to the reference element 22 by the fixing portions 32 in a manner generating an elastic tension pressing the outer periphery of the main portions 25a, 25b of the rods 24a, 24b against the activation element 26. In consequence, the activation element 26 is pushed away from the reference element 22 and the activation element 26 does not contact the electrical switch 30, which therefore is not activated.

The movement of the activation element 26 away from the reference element 22 is delimited by the cover plate 28 attached to the base 20

For activating the electrical switch 30, a force F is applied to the cover plate 28 deforming at least a portion of the cover element 28 and pushing the activation element 26 towards the reference element 22 (see FIGS. 6a, 6b, which do not include the cover element 28).

Due to the force F applied to the activation element 26, the bent/cranked end portions 23a, 23b of the rods 24a, 24b are elastically deformed and/or moved within the fixing portions 32 allowing the main portions 25a, 25b of the rods 24a, 24b to move. The main portions 25a, 25b of the rods 24a, 24b in particular may pivot with respect to the fixing portions 32. As a result, the width of the gap 29 formed between the reference element 22 and the activation element 26 is reduced and the activation element 26 moves towards the reference element 22. When the activation element 26 has moved a certain distance towards the reference element 22, it contacts and activates the electrical switch 30.

As soon as the activation element 26 is released, i.e. when no actuating force F is applied to the activation element 26 anymore, the elastic forces of the rods 24a, 24b push the rods 24a, 24b, and in consequence also the activation element 26, back into the released position depicted in FIGS. 5a and 5b.

The skilled person understands that the configuration of the rods 24a, 24b depicted in FIGS. 3, 4, 5a, 5b, 6a and 6b is only exemplary, and that alternative configurations may be employed as well.

Non-limiting examples of such configurations are schematically illustrated in FIGS. 7 to 11. For reasons of clarity, only the reference element 22 and the rods 24a-24d are depicted in FIGS. 7 to 11.

FIG. 7 depicts a configuration in which the two rods 24a, 24b are arranged in an L-shaped configuration. When the two rods 24a, 24b are projected onto the reference element 22, the projections do not intersect each other.

FIG. 8 depicts a configuration comprising three roods 24a, 24b, 24c arranged in a triangular configuration forming an equilateral triangle. In the depicted configuration, the projections of the three rods 24a, 24b, 24c onto the reference element 22 do not intersect each other as well.

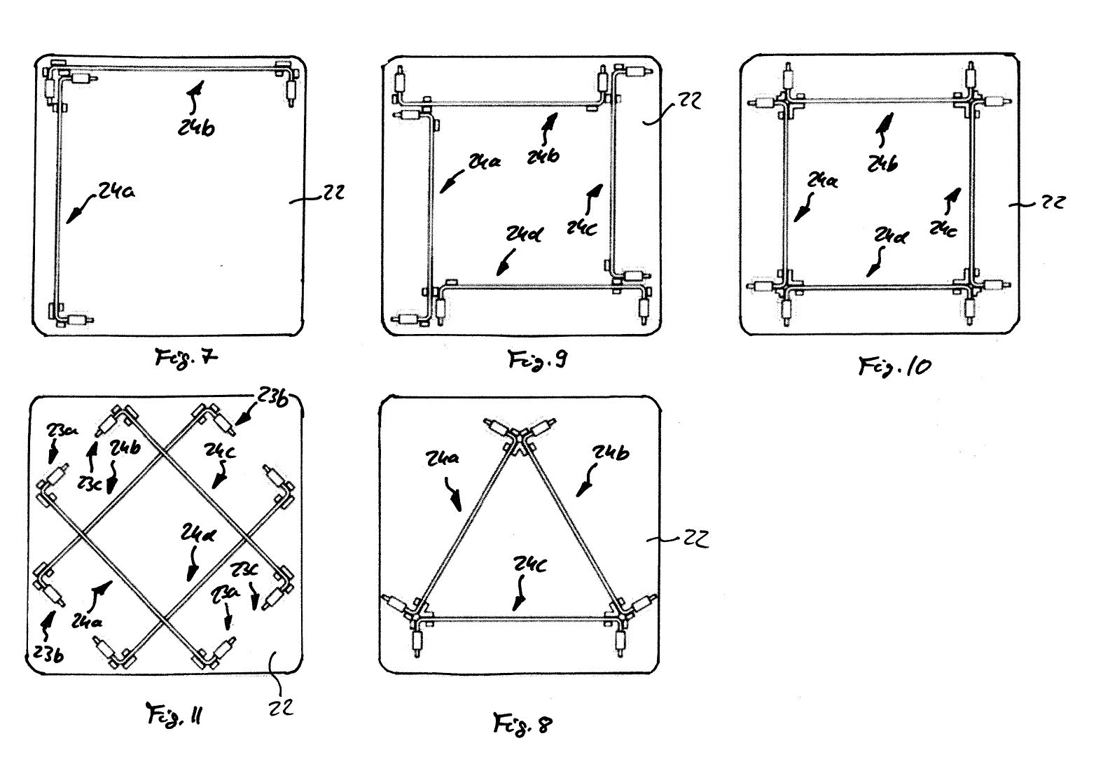

FIGS. 9 to 11 depict configurations comprising four rods 24a-24d, respectively.

In the configurations shown in FIGS. 9 and 10, the rods 24a-24d are arranged forming a rectangle, in particular a square. The projections of the rods 24a-24d onto the reference element 22 do not intersect each other.

In the configuration shown in FIG. 9, the rods 24a-24d are arranged in a nested configuration in which the arcuate portions of each rod 24a-24d are arranged next to a straight main portion 25a-25d of an adjacent rod 24a-24d, respectively. In the configuration shown in FIG. 10, the arcuate portions formed between the main portions 25a-25d and the bent/cranked portions 23a-23d of the rods 24a-24d are arranged next to each other almost abutting each other.

In the configuration depicted in FIG. 11, the rods 24a-24d are arranged in a configuration in which the projections of the rods 24a-24d onto the reference element 22 intersect each other. The rods 24a-24d in particular are arranged forming two pairs of parallel extending rods 24a-24d. The two pairs are arranged orthogonally with respect to each other forming a central rectangle 38, in particular a central square, defined by the main portions 25a-25d of the rods 24a-24d.

In the configuration depicted in FIG. 11, the bent/cranked end portions 23a-23d of the two rods 24a-24d of each pair extend towards each other. In alternative configurations not shown in the figures, the bent/cranked end portions 23a-23d of the two rods 24a-24d of each pair may be oriented in the same direction, or they may be oriented facing away from each other.

Embodiments of the present invention are not limited to the configurations illustrated in the figures. The skilled person will understand that the rods 24a-24d may be arranged in alternative geometrical configurations not shown in the figures and that configurations comprising more than four rods 24a-24d may be used.

In the configurations illustrated in FIGS. 3 to 11, all rods 24a-24d have the same length. This feature, however, is not mandatory. Instead, configurations comprising rods 24a-24d having different lengths may be employed as well.

The rods 24a-24d employed in an elevator control button assembly 7 according to exemplary embodiments of the invention prevent an undesirable tilting and/or jamming of the activation element 26 enhancing the reliability of the elevator control button assembly 7. As a result, a reliable elevator control button assembly 7 having a comparatively large activation surface may be provided.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention is not limited to the particular embodiments disclosed, but that the invention includes all embodiments falling within the scope of the claims.

### REFERENCES

2 elevator system

3 tension member

4 hoistway

5 drive

6 elevator car

7 elevator control button assembly

7a elevator hall call button

7b elevator cat control button

8 landing

9 landing door frame

10 landing door

11 elevator car door

12a, 12b landing door panes

14 wall

15 elevator control

16 floor of the elevator car

17 sidewall of the elevator car

18 ceiling of the elevator car

19 position sensor

20 base

22 reference element

23a-23d end portions of the rods

24a-24d rods

25a-25d main portions of the rods

26 activation elements

27 opening

28 cover

29 gap

30 electrical switch

32 fixing portion

34 guiding portion

36 apertures

38 central rectangle

40 light source

What is claimed is:

1. Elevator control button (7), in particular an elevator hall call button (7a) or an elevator car control button (7b), comprising:
a stationary reference element (22);
an activation element (26), which is movable with respect to the reference element (22); and
at least two rods (24a-24d) extending non-parallel to each other between the reference element (22) and the activation element (26), each of the rods (24a-24d) contacting the reference element (22) and the activation element (26), respectively;
wherein the at least two rods (24a-24d) are configured to move when the activation element (26) is moved with respect to the reference element (22).

2. Elevator control button (7) according to claim 1, wherein the reference element (22) and the activation element (26) are planar elements extending parallel to each other.

3. Elevator control button (7) according to claim 2, wherein the planar activation element (26) has an extension of at least 5 cm×5 cm in length and width directions, in particular an extension of at least 8 cm×8 cm, more particularly an extension of at least 10 cm×10 cm.

4. Elevator control button (7) according to claim 1, further comprising at least one electrical switch (30) configured to be activated by the movement of the activation element (26).

5. Elevator control button (7) according to claim 4, wherein the at least two rods (24a-24d) are configured for pushing the activation element (26) into a released position, in which the electrical switch (30) is not activated, when no external force is applied to the activation element (26).

6. Elevator control button (7) according to claim 1, wherein at least one of the rods (24a-24d) comprises a main portion (25a-25d) and at least one end portion (23a-23d) which is bent or cranked with respect to the main portion (25a-25d), wherein the at least one rod (24a-24d) in particular comprises two bent or cranked end portions (23a-23d).

7. Elevator control button (7) according to claim 6, wherein the at least one end portion (23a-23d) is bent or cranked at an angle between 85° and 95°, in particular at an angle of 88° to 92°, more particularly at an angle of 90° with respect to the main portion (25a-25d).

8. Elevator control button (7) according to claim 1, wherein at least one of the reference element (22) and the activation element (26) comprises at least one fixing portion (32) configured for fixing one of the rods (24a-24d), in particular an end portion (23a-23d) of the one of the rods (24a-24d), to the respective element (22, 26), wherein the at least one fixing portion (32) in particular is configured for elastically fixing the one of the rods (24a-24d).

9. Elevator control button (7) according to claim 1, wherein at least one of the reference element (22) and the activation element (26) comprises at least one guiding portion (34) configured for guiding one of the rods (24a-24d), in particular an end portion (23a-23d) of the one of the rods (24a-24d).

10. Elevator control button (7) according to claim 1, comprising three or four rods (24a-24d), wherein the three rods (24a-24d) in particular are arranged in a triangular configuration, and wherein the four rods (24a-24d) in particular are arranged in a rectangular configuration, more particularly in a quadratic configuration.

11. Elevator control button (7) according to claim 1, wherein at least two of the rods (24a-24d) are arranged in an L-shaped configuration or in an X-shaped configuration.

12. Elevator control button (7) according to claim 1, wherein projections of at least two rods (24a-24d) onto the reference element (22) intersect with each other.

13. Elevator control button (7) according to claim 1, wherein projections of the rods (24a-24d) onto the reference element (22) do not intersect with each other.

14. Elevator control button (7) according to claim 1, wherein the activation element (26) is at least partially transparent and the elevator control button assembly (7) further comprises at least one light source (40) configured for illuminating the activation element (26).

15. Elevator system (2) comprising an elevator car (6) traveling along a hoistway (14) and at least one elevator control button (7) according to claim 1.
